(19) United States
(12) Patent Application Publication
(10) Pub. No.: US 2018/0006338 A1
(43) Pub. Date: Jan. 4, 2018

(54) ASSEMBLED BATTERY AND BATTERY PACK USING THE SAME

(71) Applicant: Kabushiki Kaisha Toshiba, Minato-ku (JP)

(72) Inventors: Tetsuya SASAKAWA, Yokohama (JP); Norio Takami, Yokohama (JP)

(73) Assignee: Kabushiki Kaisha Toshiba, Minato-ku (JP)

(21) Appl. No.: 15/689,753

(22) Filed: Aug. 29, 2017

Related U.S. Application Data
(63) Continuation of application No. PCT/JP2015/075719, filed on Sep. 10, 2015.

(51) Int. Cl. H01M 10/46; H01M 10/0525; H01M 2/10; H01M 4/505; H01M 4/485; H01M 4/525; H01M 4/58; H01M 4/02

(52) U.S. Cl. CPC H01M 10/46; H01M 4/525; H01M 10/0525; H01M 4/58; H01M 2/1016; H01M 4/505; H01M 4/485; H01M 2004/028

(57) ABSTRACT

There are provided an assembled battery and a battery pack having excellent cycle characteristics with respect to high rate charging and discharging. An assembled battery according to an embodiment includes at least one first single cell and at least one second single cell that are connected in series. The first single cell includes a positive electrode containing an active material represented by the general formula LiMO₂ (M includes at least one element selected from the group consisting of Ni, Co, and Mn) and a negative electrode including a titanium-containing oxide. The second single cell includes a positive electrode containing an active material represented by the general formula LiM′PO₄ (M′ includes at least one element selected from the group consisting of Fe, Mn, Co, and Ni) and a negative electrode including a titanium-containing oxide. The ratio of a charging resistance of the second single cell to a charging resistance of the first single cell is 1 or more and 1.5 or less if an open circuit voltage when the at least one first single cell and the at least one second single cell are connected in series is 4.5 V.

### FIELD

Embodiments described herein relate to an assembled battery, and particularly, to an assembled battery including an assembly of nonaqueous electrolyte batteries, and a battery pack using the same.

### BACKGROUND

In a lithium ion battery in which a lithium titanium composite oxide is used for a negative electrode, since a volume change in the negative electrode according to charging and discharging is small, cycle characteristics are excellent. In addition, in particular, in a battery using a lithium titanium composite oxide, since hardly any lithium metal precipitates in principle in a lithium insertion and extract reaction of the lithium titanium composite oxide, even if charging and discharging are repeated at a high current, performance is little degraded.

Meanwhile, when the above battery is used for a power supply system, an assembled battery in which a plurality of batteries are connected in series to correspond to a voltage range of the power supply system is used. In this case, a plurality of single cells of one type connected in series can be used. However, on the other hand, in order to further increase the compatibility of a voltage range, single cells of two or more types in which a positive electrode material or a negative electrode material is different can be used.

However, when single cells of two or more types are used to prepare an assembled battery, changes in voltage with respect to charging depths of active materials are different. Therefore, overcharging or overdischarging may occur in one of the single cells which results in a decrease of lifespans of the single cell and the assembled battery. In particular, when an oxide having a layered rock-salt type structure is used for a positive electrode of one single cell, a significant decrease in capacity is caused when overcharging or overdischarging occurs.

An assembled battery of an embodiment is obtained by connecting at least one first single cell and at least one second single cell in series. The first single cell includes a positive electrode containing an active material represented by the general formula LiMO₂ (M includes at least one element selected from the group consisting of Ni, Co, and Mn), and a negative electrode including a titanium-containing oxide. The second single cell includes a positive electrode containing an active material represented by the general formula LiM′PO₄ (M′ includes at least one element selected from the group consisting of Fe, Mn, Co, and Ni) and a negative electrode including a titanium-containing oxide. The ratio of a charging resistance of the second single cell to a charging resistance of the first single cell is 1 or more and 1.5 or less if an open circuit voltage when the at least one first single cell and the at least one second single cell are connected in series is 4.5 V.

### BRIEF DESCRIPTION OF DRAWINGS

FIG. 1 is a schematic diagram showing a cross section of an example of a nonaqueous electrolyte battery according to a first embodiment.

FIG. 2 is a schematic diagram showing an enlarged cross section of a part A in FIG. 1.

FIG. 3 is an exploded perspective view showing a battery pack according to a second embodiment.

FIG. 4 is a block diagram showing an electric circuit included in the battery pack in FIG. 3.

### DETAILED DESCRIPTION

An assembled battery of an embodiment will be described below in detail.

### First Embodiment

An assembled battery according to a first embodiment is an assembled battery in which at least one first single cell including a positive electrode containing an active material represented by the general formula LiMO₂ (M includes at least one element selected from the group consisting of Ni, Co, and Mn), and a negative electrode including a titanium-containing oxide, and at least one second single cell including a positive electrode containing an active material represented by the general formula LiM′PO₄ (M′ includes at least one element selected from the group consisting of Fe, Mn, Co, and Ni) and a negative electrode including a titanium-containing oxide, are connected in series. The ratio of a charging resistance of the second single cell to a charging resistance of the first single cell is 1 or more and 1.5 or less if an open circuit voltage when the at least one first single cell and the at least one second single cell are connected in series is 4.5 V.

In the assembled battery according to the present embodiment, since different active materials are used for the first and second single cells, compatibility is exhibited in a broad voltage range. Furthermore, since the active material represented by LiMO₂ is used for the first single cell and the active material represented by LiM′PO₄ is used for the second single cell, the second single cell deteriorates less from overcharging than the first single cell. Here, in the assembled battery according to the present embodiment, when the ratio of the charging resistance of the second single cell to the charging resistance of the first single cell is set to 1 or more, the voltage of the second single cell that deteriorates less from overcharging is likely to increase compared to the voltage of the first single cell when charging is performed at a high rate so that it is possible to prevent the first single cell from being overcharged. In addition, when the ratio of the charging resistance of the second single cell to the charging resistance of the first single cell is set to 1.5 or less, it is possible to prevent capacity deterioration which is caused due to a significant increase in voltage of the second single cell when the above ratio is 1.5 or more.

A method of measuring a charging resistance will be described below.

An assembled battery in which the at least one first single cell and the at least one second single cell are connected in series is subjected to constant current discharging at a rate of IC up to 3.0 V, and then there is a pause for 1 hour. Next, the assembled battery undergoes constant current charging at a rate of 1 C up to 4.5 V and then undergoes constant voltage charging at 4.5 V for 3 hours. The connection between the first single cell and the second single cell is disconnected, and open circuit voltages of the single cells are measured. Then, charging is performed at a rate of 10 C, and a voltage one second after the charging starts is measured. A charging resistance value is calculated by the following Formula (I).

(Vc−V1)/Ic (I)

Here, Vc denotes a voltage of a single cell one second after charging starts at a rate of 10 C, V1 denotes an open circuit voltage, and Ic denotes a charge current value (10 C).

In addition, in the assembled battery according to the first embodiment, the ratio of the discharging resistance of the second single cell to the discharging resistance of the first single cell is preferably 1 or more and 1.5 or less if an open circuit voltage when the at least one first single cell and the at least one second single cell are connected in series is 4.0 V.

When the ratio of the discharging resistance of the second single cell to the discharging resistance of the first single cell is set to 1 or more, the voltage of the second single cell that deteriorates less from overdischarging is likely to decrease compared to the voltage of the first single cell when discharging is performed at a high rate so that it is possible to prevent the first single cell from being overdischarged. In addition, when the ratio of the discharging resistance of the second single cell to the discharging resistance of the first single cell is set to 1.5 or more, a significant voltage drop of the second single cell occurs and capacity deterioration is caused. Therefore, it is preferable that the ratio be set to 1.5 or less.

A method of measuring a discharging resistance will be described below.

The assembled battery in which the at least one first single cell and the at least one second single cell are connected in series undergoes constant current charging at a rate of 1 C up to 4.7 V, and there is a pause for 1 hour. Next, the assembled battery undergoes constant current discharging at a rate of 1 C up to 4.0 V, and then undergoes constant voltage discharge at a 4.0 V for 3 hours. The connection between the first single cell and the second single cell is disconnected, and open circuit voltages of the single cells are measured. Then, discharging is performed at a rate of 10 C, and a voltage one second after the discharging starts is measured. A discharging resistance value is calculated by the following Formula (II).

(Vd−V2)/Id (II)

Here, Vd denotes a voltage of a single cell one second after charging starts at a rate of 10 C, V2 denotes an open circuit voltage, and Id denotes a charge current value (10 C).

The charging resistance and the discharging resistance in the first single cell and the second single cell can be adjusted by changing the electrode thicknesses of the positive electrode and the negative electrode, the amount of a conductive material, or the electrode density, or by changing an electrolyte used for a single cell.

In the assembled battery according to the first embodiment, at least one first single cell and at least one second single cell are assembled and connected in series. At least one of each of the single cells may be used for assembly. However, for example, the number of first single cells and the number of second single cells is the same. When the first single cell and the second single cell are connected in series, the connection arrangement of the batteries is arbitrary. However, for example, when two or more assemblies of the first single cell and the second single cell are used, the first single cells and the second single cells may be alternately connected.

Next, configurations of the first single cell and the second single cell includes in the assembled battery according to the first embodiment will be described. In the present embodiment, nonaqueous electrolyte batteries are used as these single cells.

The nonaqueous electrolyte battery according to the present embodiment includes at least a positive electrode and a negative electrode including the above-described active materials, and a nonaqueous electrolyte. More specifically, the nonaqueous electrolyte battery according to the present embodiment includes an exterior member, a positive electrode stored in the exterior member, a negative electrode that is stored to be spatially separated from the positive electrode in the exterior member, for example, with a separator therebetween, and includes the above active materials for a battery, and a nonaqueous electrolyte filled into the exterior member.

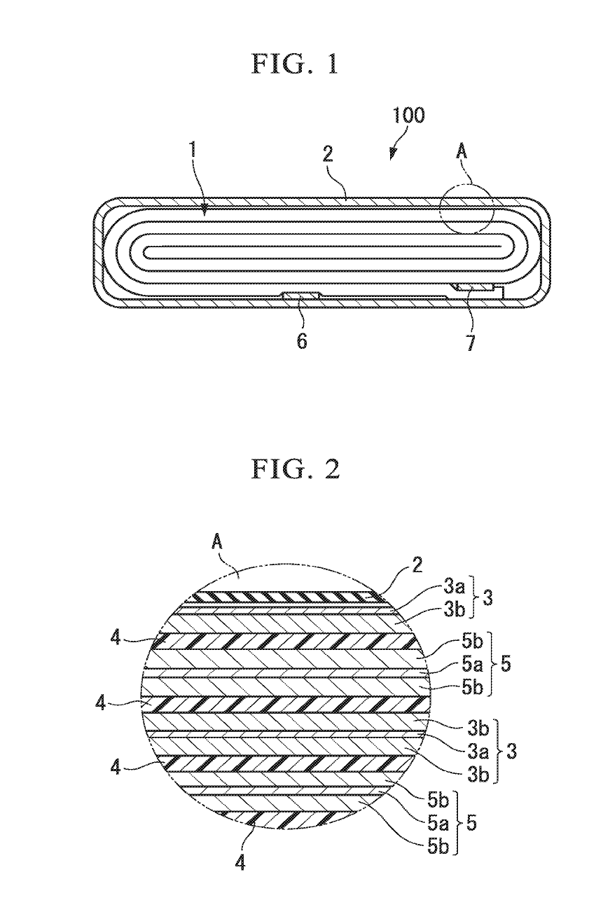

As an example of the nonaqueous electrolyte battery according to the present embodiment, a flat nonaqueous electrolyte battery (nonaqueous electrolyte battery) 100 will be described below with reference to FIG. 1 and FIG. 2. FIG. 1 is a schematic diagram showing a cross section of the flat nonaqueous electrolyte battery 100. In addition, FIG. 2 is an enlarged cross-sectional view of a part A shown in FIG. 1. Here, FIG. 1 and FIG. 2 are schematic diagrams for describing the nonaqueous electrolyte battery according to the present embodiment. The shapes, sizes, proportions, and the like may be different from those of the actual device, and designs thereof can be appropriately changed in consideration of the following description and known techniques.

The nonaqueous electrolyte battery 100 shown in FIG. 1 has a configuration in which a flat winding electrode group 1 is stored in an exterior member 2. The exterior member 2 may be laminate film formed in a bag shape or a metal container. In addition, the flat winding electrode group 1 is formed by winding a laminate in which a negative electrode 3, a separator 4, a positive electrode 5, and a separator 4 are laminated in this order from the outside, that is, from the side of the exterior member 2, in a spiral shape and press molding the wound laminate. As shown in FIG. 2, the negative electrode 3 positioned on the outermost circumference has a configuration in which a negative electrode layer 3b is formed on one inner side surface of a negative electrode current collector 3a. The negative electrode 3 in a portion other than the outermost circumference has a configuration in which the negative electrode layer 3b is formed on both surfaces of the negative electrode current collector 3a. Therefore, the flat nonaqueous electrolyte battery 100 according to the present embodiment has a configuration in which a negative electrode active material in the negative electrode layer 3b includes the active material for a battery according to the first embodiment. In addition, the positive electrode 5 has a configuration in which a positive electrode layer 5b is formed on both surfaces of a positive electrode current collector 5a. Here, in place of the separator 4, a gel-like nonaqueous electrolyte to be described below may be used.

In the winding electrode group 1 shown in FIG. 1, a negative electrode terminal 6 is electrically connected to the negative electrode current collector 3a of the negative electrode 3 on the outermost circumference in the vicinity of its outer peripheral end. A positive electrode terminal 7 is electrically connected to the positive electrode current collector 5a of the inside positive electrode 5 shown in FIG. 2. The negative electrode terminal 6 and the positive electrode terminal 7 extend to the outside of the bag-like exterior member 2 or are connected to an extraction electrode that is included in the exterior member 2.

When the nonaqueous electrolyte battery 100 including an exterior member formed of a laminate film is produced, the winding electrode group 1 in which the negative electrode terminal 6 and the positive electrode terminal 7 are connected is inserted into the bag-like exterior member 2 having an opening, a liquid nonaqueous electrolyte is injected from the opening of the exterior member 2, and additionally, the opening of the bag-like exterior member 2 is thermally sealed with the negative electrode terminal 6 and the positive electrode terminal 7 interposed therebetween. Therefore, the winding electrode group 1 and liquid nonaqueous electrolyte are completely sealed.

In addition, when the nonaqueous electrolyte battery 100 including an exterior member formed of a metal container is produced, the winding electrode group 1 in which the negative electrode terminal 6 and the positive electrode terminal 7 are connected is inserted into a metal container having an opening, a liquid nonaqueous electrolyte is injected from the opening of the exterior member 2, and additionally, a lid is attached to the metal container to seal the opening.

For the negative electrode terminal 6, for example, a material having electric stability and conductivity in the range of 1 V or more and 3 V or less which is a potential with respect to lithium can be used. Specifically, aluminum (Al) or an aluminum alloy containing an element such as magnesium (Mg), titanium (Ti), zinc (Zn), manganese (Mn), iron (Fe), copper (Cu) or silicon (Si) in addition to aluminum are exemplary examples. In addition, more preferably, the negative electrode terminal 6 is made of the same material as the negative electrode current collector 3a in order to reduce a contact resistance with respect to the negative electrode current collector 3a.

For the positive electrode terminal 7, a material having electric stability and conductivity in the range of 3 to 4.25 V which is a potential with respect to lithium can be used. Specifically, aluminum or the above-described aluminum alloys are exemplary examples. Preferably, the positive electrode terminal 7 is made of the same material as the positive electrode current collector 5a in order to reduce the contact resistance with respect to the positive electrode current collector 5a.

The components of the first single cell and the second single cell which are the exterior member 2, the negative electrode 3, the positive electrode 5, the separator 4, and the nonaqueous electrolyte will be described below in detail.

### 1) Exterior Member

The exterior member 2 is formed of a laminate film with a thickness of 0.5 mm or less. Alternatively, as the exterior member, a metal container with a thickness of 1.0 mm or less is used. More preferably, the metal container has a thickness of 0.5 mm or less.

The shape of the exterior member 2 can be selected from among a flat shape (a thin shape), a square shape, a cylindrical shape, a coin shape, and a button shape. Examples of the exterior member include an exterior member for a small battery mounted in, for example, a portable electronic device, and an exterior member for a large battery mounted in a two-wheel to four-wheel vehicle according to the size of the battery.

As the laminate film, a multilayer film in which a metal layer is interposed between resin layers is used. As the metal layer, an aluminum foil or an aluminum alloy foil is preferably used for weight reduction. For the resin layers, a polymer material, for example, polypropylene (PP), polyethylene (PE), nylon, or polyethylene terephthalate (PET), can be used. The laminate film can be formed into the shape of the exterior member with sealing by thermal fusion.

The metal container is made of aluminum, an aluminum alloy, or the like. As the aluminum alloy, an alloy containing an element such as magnesium, zinc, or silicon in addition to aluminum is preferable. When a transition metal such as iron, copper, nickel, or chromium is included in the alloy, the amount thereof is preferably 100 ppm by mass or less.

### 2) Negative Electrode

The negative electrode 3 includes the current collector 3a and the negative electrode layer 3b that is formed on one surface or both surfaces of the current collector 3a, and includes an active material, a conductive agent, and a binding agent.

Exemplary active materials used for the negative electrode include various titanium-containing oxides. Examples of the titanium-containing oxide include lithium titanate, titanium dioxide, and niobium titanium oxide.

The conductive agent improves current collection performance of the active material, and minimizes a contact resistance with respect to the current collector. Examples of the conductive agent include acetylene black, carbon black, and graphite.

The binding agent can bind the active material and the conductive agent. Examples of the binding agent include polytetrafluoroethylene (PTFE), polyvinylidene fluoride (PVdF), fluorocarbon rubber, and styrene butadiene rubber.

The active material, the conductive agent, and the binding agent in the negative electrode layer 3b are preferably combined in proportions of 70 mass % or more and 96 mass % or less, 2 mass % or more and 28 mass % or less, and 2 mass % or more and 28 mass % or less. When the amount of the conductive agent is set to 2 mass % or more, it is possible to improve current collection performance of the negative electrode layer 3b and improve characteristics of the nonaqueous electrolyte secondary battery 100 at a high current. In addition, when the amount of the binding agent is set to 2 mass % or more, it is possible to enhance the binding property between the negative electrode layer 3b and the current collector 3a, and it is possible to improve cycle characteristics. Meanwhile, it is preferable that the conductive agent and the binding agent be set to 28 mass % or less to increase the capacity.

The current collector 3a is preferably an aluminum foil or an aluminum alloy foil containing an element such as Mg, Ti, Zn, Mn, Fe, Cu, or Si in addition to aluminum which is electrochemically stable in a potential range of 1 V or more.

The negative electrode 3 is produced, for example, when an active material, a conductive agent, and a binding agent are suspended in a commonly used solvent to prepare a slurry, the slurry is applied to the current collector 3a and dried, and pressing is then performed. Alternatively, the negative electrode 3 may be produced when an active material, a conductive agent, and a binding agent are formed into a pellet-like negative electrode layer 3b, and the layer is formed on the current collector 3a.

### 3) Positive Electrode

The positive electrode 5 includes the current collector 5a and the positive electrode layer 5b that is formed on one surface or both surfaces of the current collector 5a and includes an active material, a conductive agent, and a binding agent.

As the positive electrode active material used for the first single cell, an oxide represented by the general formula LiMO₂ (M includes at least one element selected from the group consisting of Ni, Co, and Mn) can be used. In addition, as the positive electrode active material used for the second single cell, an oxide which is an active material of the present embodiment described above and represented by the general formula LiM′PO₄ (M′ includes at least one element selected from the group consisting of Fe, Mn, Co, and Ni) can be used.

In the first single cell, the positive electrode including the active material represented by the general formula LiMO₂ may have generally a layered rock-salt type structure as a whole. The layered rock-salt type structure is a face-centered cubic lattice structure (rock-salt type structure) which is a general structure of an oxide and in which metals represented by M and lithium atoms are regularly arranged to form a layered structure.

In the second single cell, the positive electrode including the active material represented by the general formula LiM′PO₄ may have generally an olivine type structure (olivine structure) as a whole. The olivine type structure generally refers to a crystal structure with a hexagonal closed-packed array of oxygen ions with tetrahedral sites occupied by the element P and octahedral sites occupied by Li or Fe ions. The positive electrode in the second single cell has excellent thermal stability because it has an olivine type structure.

The primary particle size of the positive electrode active material is preferably 100 nm or more and 1 μm or less. A positive electrode active material with a primary particle size of 100 nm or more is easy to handle in industrial production. A positive electrode active material with a primary particle size of 1 μm or less can allow diffusion of lithium ions to progress smoothly in a solid.

The specific surface area of the positive electrode active material is preferably 0.1 m²/g or more and 10 m²/g or less. A positive electrode active material having a specific surface area of 0.1 m²/g or more can ensure there are sufficient insertion and extract sites of lithium ions. A positive electrode active material having a specific surface area of 10 m²/g or less is easy to handle in industrial production, and can ensure favorable charging and discharging cycle performance.

The conductive agent improves current collection performance of the active material, and minimizes a contact resistance with respect to the current collector. Examples of the conductive agent may include a carbonaceous material such as acetylene black, carbon black, or graphite.

The binding agent binds the active material and the conductive agent. Examples of the binding agent may include polytetrafluoroethylene (PTFE), polyvinylidene fluoride (PVdF), and fluorocarbon rubber.

The active material, the conductive agent, and the binding agent in the positive electrode layer 5b are preferably combined in proportions of 80 mass % or more and 95 mass % or less, 3 mass % or more and 18 mass % or less, and 2 mass % or more and 17 mass % or less. When the amount of the conductive agent is set to 3 mass % or more, the above-described effects can be exhibited. When the amount of the conductive agent is set to 18 mass % or less, it is possible to reduce decomposition of the nonaqueous electrolyte on the surface of the conductive agent during high temperature storage. When the amount of the binding agent is set to 2 mass % or more, a sufficient positive electrode strength is obtained. When the amount of the binding agent is set to 17 mass % or less, it is possible to reduce the amount of the binding agent which is an insulating material mixed into the positive electrode and reduce the internal resistance.

The current collector is preferably, for example, an aluminum foil or an aluminum alloy foil containing an element such as Mg, Ti, Zn, Mn, Fe, Cu, or Si in addition to aluminum.

The positive electrode 5 is produced, for example, when an active material, a conductive agent, and a binding agent are suspended in a commonly used solvent to prepare a slurry, the slurry is applied to the current collector 5a and dried, and pressing is then performed. Alternatively, the positive electrode 5 may be produced when an active material, a conductive agent, and a binding agent are formed into a pellet-like positive electrode layer 5b, and the layer is formed on the current collector 5a.

### 4) Nonaqueous Electrolyte

As the nonaqucous electrolyte, for example, a liquid nonaqucous electrolyte prepared by dissolving an electrolyte in an organic solvent or a gel-like nonaqueous electrolyte in which a liquid electrolyte and a polymer material are combined, can be used.

In the liquid nonaqueous electrolyte, preferably, an electrolyte is dissolved at a concentration of 0.5 M or more and 2.5 M or less in an organic solvent.

Examples of the electrolyte may include lithium salts such as lithium perchlorate (LiClO₄), lithium hexafluorophosphate (LiPF₆), lithium tetrafluoroborate (LiBF₄), lithium arsenic hexafluoride (LiAsF₆), lithium trifluoromethasulfonate (LiCF₃SO₃), and bistrifluoromethylsulfonylimide lithium [LiN(CF₃SO₂)₂], or mixtures thereof. An electrolyte that hardly oxidizes even at a high potential is preferable, and LiPF₆ is most preferable.

Examples of the organic solvent may include a cyclic carbonate such as propylene carbonate (PC), ethylene carbonate (EC), and vinylene carbonate; a linear carbonate such as diethyl carbonate (DEC), dimethyl carbonate (DMC), and methyl ethyl carbonate (MEC); a cyclic ether such as tetrahydrofuran (THF), 2-methyltetrahydrofuran (2MeTHF), and dioxolane (DOX); a linear ether such as dimethoxyethane (DME), and diethylethane (DEE); γ-butyrolactone (GBL), acetonitrile (AN), and sulfolane (SL). These organic solvents can be used alone or used in the form of a solvent mixture.

Examples of the polymer material may include polyvinylidene fluoride (PVdF), polyacrylonitrile (PAN), and polyethylene oxide (PEO).

As a preferable organic solvent, a solvent mixture in which at least two or more selected from the group consisting of propylene carbonate (PC), ethylene carbonate (EC) and diethyl carbonate (DEC) are mixed, or a solvent mixture containing γ-butyrolactone (GBL) may be used. When such a solvent mixture is used, it is possible to obtain a nonaqueous electrolyte secondary battery having excellent high temperature characteristics.

5) Separator

As the separator 4, a porous film including, for example, polyethylene, polypropylene, cellulose, or polyvinylidene fluoride (PVdF), or a synthetic resin nonwoven fabric can be used. A preferable porous film is made of polyethylene or polypropylene, melts at a certain temperature, and can block a current, thereby improving safety.

According to the present embodiment described above, it is possible to provide a nonaqueous electrolyte secondary battery having excellent charging and discharging cycle performance.

### Second Embodiment

Next, a battery pack according to a second embodiment will be described in detail. Here, configurations the same as in the first embodiment will not be described.

The battery pack according to the present embodiment includes at least one assembled battery according to the first embodiment. The single cells (the first and second single cells) constituting the assembled battery are arranged to be electrically connected in series, in parallel, or in parallel series.

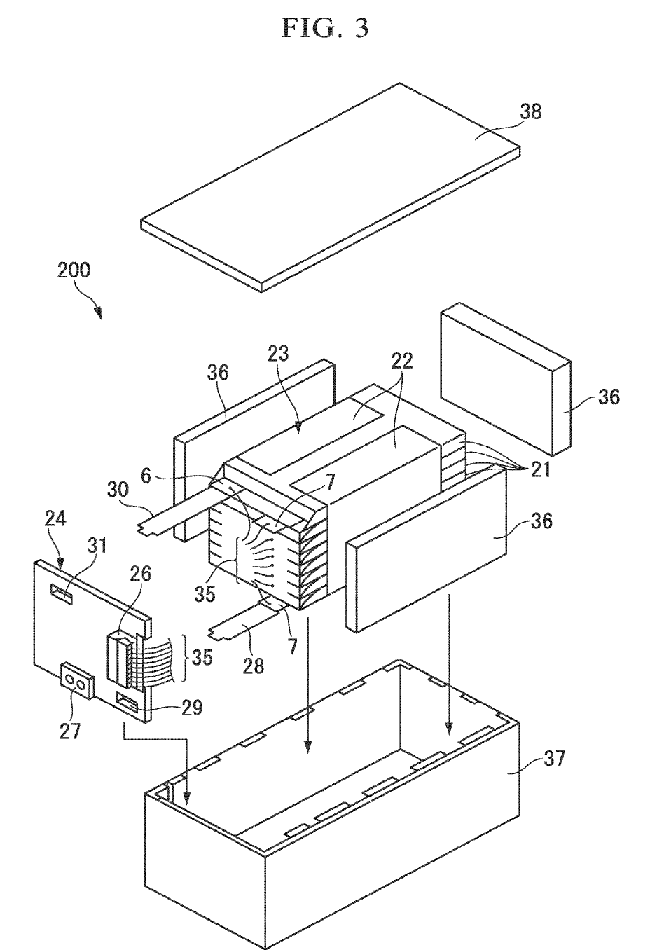

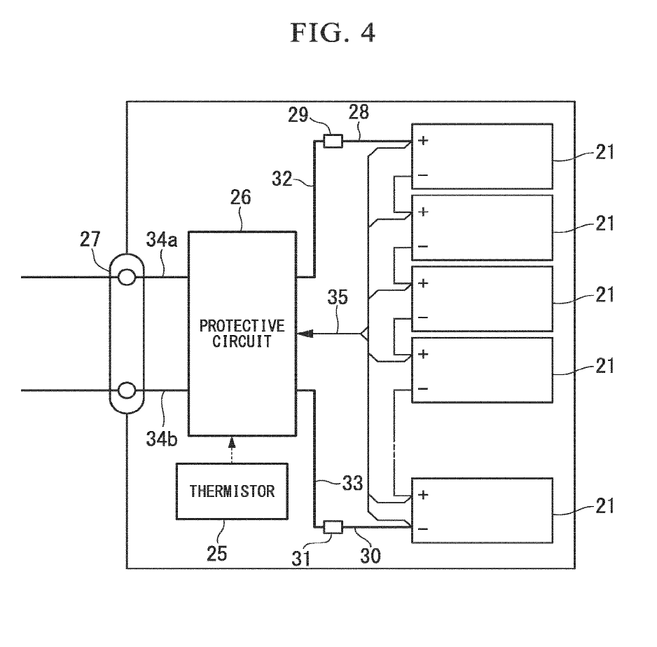

A battery pack 200 will be described in detail with reference to FIG. 3 and FIG. 4. In the battery pack 200 shown in FIG. 3, the flat nonaqucous electrolyte solution battery 100 shown in FIG. 2 is used as a single cell 21.

The plurality of single cells 21 are laminated so that the negative electrode terminal 6 and the positive electrode terminal 7 extended to the outside are aligned in the same direction, and are fastened using an adhesive tape 22 to form an assembled battery 23. As shown in FIG. 4, these single cells 21 are electrically connected to each other in series. In the present embodiment, the first or second single cell in the first embodiment is used as the single cell 21, and the first and second single cells are alternately connected in series. The example shown in FIG. 3 shows the assembled battery of the first embodiment in which four first single cells and four second single cells (the single cells 21) are alternately connected in series and a total of eight single cells are included.

A printed wiring board 24 is arranged to face a side surface of the single cell 21 from which the negative electrode terminal 6 and the positive electrode terminal 7 extend. As shown in FIG. 4, a thermistor 25, a protective circuit 26, and an energizing terminal 27 for an external device are mounted on the printed wiring board 24. Here, on a surface of the printed wiring board 24 that faces the assembled battery 23, an insulating plate (not shown) is attached in order to avoid an unnecessary connection with a wiring of the assembled battery 23.

A positive electrode-side lead 28 is connected to the positive electrode terminal 7 positioned on the lowermost layer of the assembled battery 23, and a tip thereof is inserted into a positive electrode-side connector 29 of the printed wiring board 24 and electrically connected thereto. A negative electrode-side lead 30 is connected to the negative electrode terminal 6 positioned on the uppermost layer of the assembled battery 23, and a tip thereof is inserted into a negative electrode-side connector 31 of the printed wiring board 24 and electrically connected thereto. The connectors 29 and 31 are connected to the protective circuit 26 through wirings 32 and 33 formed on the printed wiring board 24.

The thermistor 25 is used to determine the temperature of the single cell 21 and transmits a determination signal to the protective circuit 26. The protective circuit 26 can block a positive side wiring 34a and a negative side wiring 34b between the protective circuit 26 and the energizing terminal 27 for an external device under predetermined conditions. The predetermined conditions include, for example, a temperature determined by the thermistor 25 is a predetermined temperature or higher. In addition, the predetermined conditions include the condition that an overcharge, an overdischarge, an overcurrent, or the like of the single cell 21 has been determined. The determination of such an overcharge is performed for each of the single cells 21 individually or all of the single cells 21. When determination is performed for each of the single cells 21, a battery voltage may be determined, or a positive electrode potential or a negative electrode potential may be determined. In the case of the latter, a lithium electrode used as a reference electrode is inserted into each of the single cells 21. In FIG. 3 and FIG. 4, a wiring 35 for voltage determination is connected to each of the single cells 21, and a determination signal is transmitted to the protective circuit 26 through the wiring 35.

On three side surfaces of the assembled battery 23 except the side surface from which the positive electrode terminal 7 and the negative electrode terminal 6 protrude, protective sheets 36 made of rubber or a resin are arranged.

The assembled battery 23 is stored in a storage container 37 together with the protective sheets 36 and the printed wiring board 24. That is, the protective sheets 36 are arranged on both inner sides of the storage container 37 in the long side direction and an inner side in the short side direction. The printed wiring board 24 is arranged on an inner side surface opposite thereto in the short side direction. The assembled battery 23 is positioned in a space surrounded by the protective sheets 36 and the printed wiring board 24. A cover 38 is attached to the upper surface of the storage container 37.

Here, in place of the adhesive tape 22, a heat shrinkable tape may be used to fix the assembled battery 23. In this case, protective sheets are arranged on both side surfaces of the assembled battery, a heat shrinkable tape is wound therearound, and the heat shrinkable tape is then thermally shrunk to bind the assembled battery.

While the single cells 21 are connected in series in FIG. 3 and FIG. 4, they may be connected in parallel or in a combination of series connection and parallel connection in order to increase a battery capacity. The assembled battery packs additionally may be connected in series or in parallel.

According to the present embodiment described above, it is possible to provide a battery pack having excellent charging and discharging cycle performance by using the assembled battery having excellent charging and discharging cycle performance from the first embodiment.

Here, the mode of the battery pack may be appropriately changed depending on applications. A battery pack exhibiting excellent cycle characteristics when a high current is output is preferable for applications. Specifically, a power supply of a digital camera, and automotive applications for two-wheel to four-wheel hybrid electric vehicles, two-wheel to four-wheel electric vehicles, and assisted bicycles are exemplary examples. In particular, a battery pack using a nonaqueous electrolyte secondary battery having excellent high temperature characteristics is suitably used for automotive applications.

### EXAMPLES

Examples are described below, but the present invention is not limited to the following examples unless they exceed the scope of the present invention.

### Example 1

### <Production of Positive Electrode>

As a positive electrode active material used for a first single cell, 90 mass % of LiNi_{0.5}Co_{0.2}Mn_{0.3}O₂ powder was used. As a positive electrode active material used for a second single cell, 90 mass % of LiFePO₄ powder was used. As a conductive agent, 3 mass % of acetylene black and 3 mass % of graphite were used. As a binding agent, 4 mass % of polyvinylidene fluoride (PVdF) was used. The above components were added to N-methyl pyrrolidone (NMP) and mixed in to prepare a slurry. The slurry was applied to both surfaces of a current collector formed of an aluminum foil with a thickness of 15 μm dried, and pressed to obtain a positive electrode.

### <Production of Negative Electrode>

As a negative electrode active material for the first single cell and the second single cell, 90 mass % of Li₄Ti₅O₁₂ powder was used. As a conductive agent, 7 mass % of graphite was used. As a binding agent, 3 mass % of polyvinylidene fluoride (PVdF) was used. These components and N-methyl pyrrolidone (NMP) were mixed to prepare a slurry. The slurry was applied to both surfaces of a current collector formed of an aluminum foil with a thickness 15 μm dried and pressed to obtain a negative electrode.

### <Production of Electrode Group>

As a separator, a cellulose nonwoven fabric with a thickness of 25 μm was used.

The positive electrode, the separator, the negative electrode, and the separator were laminated in that order to obtain a laminate. Next, the laminate was wound in a spiral shape, and thermally pressed at 80° C. to produce a flat electrode group. The obtained electrode group was stored in a pack formed of a laminate film having a 3-layer structure of nylon layer/aluminum layer/polyethylene layer and a thickness of 0.1 mm, and dried at 80° C. for 16 hours in a vacuum.

### <Preparation of Liquid Nonaqueous Electrolyte>

1 mol/L of LiPF₆ was dissolved as an electrolyte in a solvent mixture (volume ratio of 1:2) containing propylene carbonate (PC) and diethyl carbonate (DEC) to obtain a nonaqueous electrolyte solution.

The nonaqueous electrolyte solution was injected into the laminate film pack in which the electrode group was stored. Then, the pack was completely sealed through thermal sealing. Thereby, each single cell was obtained. One first single cell and one second single cell were connected in series to form an assembled battery.

The assembled battery was charged to 4.7 V at a rate of 1 C, and then discharged to 3.0 V, and a charging resistance and a discharging resistance of each single cell were measured according to the above method. In addition, in a cycle characteristics test of the assembled battery, charging and discharging were repeatedly performed under an environment at 45° C. in a voltage range from 4.7 V to 3.0 V at a rate of 5 C, and a change in discharge capacity was measured.

Table 1 shows the ratio of the charging resistance of the second single cell to the charging resistance of the first single cell if an open circuit voltage of the positive electrode active material and the negative electrode active material of the first single cell and the second single cell was 4.5 V, and the ratio of the discharging resistance of the second single cell to the discharging resistance of the first single cell if an open circuit voltage thereof was 4.0 V, and a discharge capacity retention rate after 1000 cycles at 45° C.

### Examples 2 to 12 and Comparative Examples 1 to 11

Assembled batteries were produced in the same method as in Example 1 except that the ratio of the charging resistance of the second single cell to the charging resistance of the first single cell if an open circuit voltage of the positive electrode active material and the negative electrode active material of the first single cell and the second single cell was 4.5 V, and the ratio of the discharging resistance of the second single cell to the discharging resistance of the first single cell if an open circuit voltage thereof was 4.0 V were changed as shown in Table 1, and evaluated.

As shown in Table 1, the capacity retention rate of the assembled batteries of Comparative Examples 1 to 11 with respect to charging and discharging cycles at 45° C. significantly decreased as the capacity of one single cell deteriorated. However, the capacity retention rate of the assembled batteries of Examples 1 to 12 showed a high value.

### Example 1-1

The five first single cells and one second single cell produced in Example 1 were connected in series to obtain an assembled battery. In the cycle characteristics test of the assembled battery, charging and discharging were repeatedly performed under an environment at 45° C. in a voltage range from 14.8 V to 9.0 V at a rate of 5 C, and a change in discharge capacity was measured.

### Example 2-1

An assembled battery was produced in the same method as in Example 1-1 except that the single cell produced in Example 2 was used, and evaluated.

### Example 3-1

An assembled battery was produced in the same method as in Example 1-1 except that the single cell produced in Example 3 was used, and evaluated.

### Comparative Example 1-1

An assembled battery was produced in the same method as in Example 1-1 except that the single cell produced in Comparative Example 1 was used, and evaluated.

### Comparative Example 2-1

An assembled battery was produced in the same method as in Example 1-1 except that the single cell produced in Comparative Example 2 was used, and evaluated.

As shown in Table 2, the capacity retention rate of the assembled batteries of Comparative Examples 1-1 and 2-1 with respect to charging and discharging cycles at 45° C. significantly decreased as the capacity of one single cell deteriorated. However, the capacity retention rate of the assembled batteries of Examples 1-1, 2-1, and 3-1 had a high value.

TABLE 1

| | | | | | Charging resistance of | Discharging resistance | |
|---|---|---|---|---|---|---|---|
| | | | | | second single cell to | of second single cell to | |
| | | | | | charging resistance of | discharging resistance of | Discharge |
| | | Negative | | Negative | first single cell when | first single cell when | capacity |
| | First single cell | electrode | Second single cell | electrode | open circuit voltage of | open circuit voltage of | retention rate (%) |
| | Positive electrode | active | Positive electrode | active | assembled battery was | assembled battery was | after 1000 cycles |
| | active material | material | active material | material | 4.5 V | 4.0 V | at 45° C. |
| Example 1 | LiNi_{0.5}Co_{0.2}Mn_{0.3}O₂ | Li₄Ti₅O₁₂ | LiFePO₄ | Li₄Ti₅O₁₂ | 1.0 | 1.0 | 94 |
| Example 2 | LiNi_{0.5}Co_{0.2}Mn_{0.3}O₂ | Li₄Ti₅O₁₂ | LiFePO₄ | Li₄Ti₅O₁₂ | 1.3 | 1.3 | 98 |
| Example 3 | LiNi_{0.5}Co_{0.2}Mn_{0.3}O₂ | Li₄Ti₅O₁₂ | LiFePO₄ | Li₄Ti₅O₁₂ | 1.5 | 1.5 | 92 |
| Example 4 | LiNi_{0.5}Mn_{0.5}O₂ | Li₄Ti₅O₁₂ | LiFePO₄ | Li₄Ti₅O₁₂ | 1.3 | 1.2 | 90 |
| Example 5 | LiCoO₂ | Li₄Ti₅O₁₂ | LiFePO₄ | Li₄Ti₅O₁₂ | 1.3 | 1.4 | 95 |
| Example 6 | LiNi_{0.5}Co_{0.2}Mn_{0.3}O₂ | TiO₂(B) | LiFePO₄ | Li₄Ti₅O₁₂ | 1.3 | 1.2 | 92 |
| Example 7 | LiNi_{0.5}Co_{0.2}Mn_{0.3}O₂ | Nb₂TiO₇ | LiFePO₄ | Li₄Ti₅O₁₂ | 1.3 | 1.2 | 92 |
| Example 8 | LiNi_{0.5}Co_{0.2}Mn_{0.3}O₂ | Li₄Ti₅O₁₂ | LiFe_{0.9}Mn_{0.1}PO₄ | Li₄Ti₅O₁₂ | 1.3 | 1.3 | 96 |
| Example 9 | LiNi_{0.5}Co_{0.2}Mn_{0.3}O₂ | Li₄Ti₅O₁₂ | LiFe_{0.9}Co_{0.1}PO₄ | Li₄Ti₅O₁₂ | 1.3 | 1.3 | 96 |
| Example 10 | LiNi_{0.5}Co_{0.2}Mn_{0.3}O₂ | Li₄Ti₅O₁₂ | LiFe_{0.9}Ni_{0.1}PO₄ | Li₄Ti₅O₁₂ | 1.3 | 1.3 | 96 |
| Example 11 | LiNi_{0.5}Co_{0.2}Mn_{0.3}O₂ | Li₄Ti₅O₁₂ | LiFePO₄ | TiO₂(B) | 1.3 | 1.3 | 94 |
| Example 12 | LiNi_{0.5}Co_{0.2}Mn_{0.3}O₂ | Li₄Ti₅O₁₂ | LiFePO₄ | Nb₂TiO₇ | 1.3 | 1.3 | 94 |
| Comparative | LiNi_{0.5}Co_{0.2}Mn_{0.3}O₂ | Li₄Ti₅O₁₂ | LiFePO₄ | Li₄Ti₅O₁₂ | 0.9 | 0.9 | 89 |
| Example 1 | | | | | | | |
| Comparative | LiNi_{0.5}Co_{0.2}Mn_{0.3}O₂ | Li₄Ti₅O₁₂ | LiFePO₄ | Li₄Ti₅O₁₂ | 1.6 | 1.6 | 89 |
| Example 2 | | | | | | | |
| Comparative | LiNi_{0.5}Mn_{0.5}O₂ | Li₄Ti₅O₁₂ | LiFePO₄ | Li₄Ti₅O₁₂ | 0.9 | 0.8 | 83 |
| Example 3 | | | | | | | |
| Comparative | LiCoO₂ | Li₄Ti₅O₁₂ | LiFePO₄ | Li₄Ti₅O₁₂ | 0.9 | 0.9 | 84 |
| Example 4 | | | | | | | |
| Comparative | LiNi_{0.5}Co_{0.2}Mn_{0.3}O₂ | TiO₂(B) | LiFePO₄ | Li₄Ti₅O₁₂ | 0.9 | 0.8 | 82 |
| Example 5 | | | | | | | |
| Comparative | LiNi_{0.5}Co_{0.2}Mn_{0.3}O₂ | Nb₂TiO₇ | LiFePO₄ | Li₄Ti₅O₁₂ | 0.9 | 0.9 | 82 |
| Example 6 | | | | | | | |
| Comparative | LiNi_{0.5}Co_{0.2}Mn_{0.3}O₂ | Li₄Ti₅O₁₂ | LiFe_{0.9}Mn_{0.1}PO₄ | Li₄Ti₅O₁₂ | 0.9 | 0.9 | 84 |
| Example 7 | | | | | | | |
| Comparative | LiNi_{0.5}Co_{0.2}Mn_{0.3}O₂ | Li₄Ti₅O₁₂ | LiFe_{0.9}Co_{0.1}PO₄ | Li₄Ti₅O₁₂ | 0.9 | 0.9 | 84 |
| Example 8 | | | | | | | |
| Comparative | LiNi_{0.5}Co_{0.2}Mn_{0.3}O₂ | Li₄Ti₅O₁₂ | LiFe_{0.9}Mi_{0.1}PO₄ | Li₄Ti₅O₁₂ | 0.9 | 0.9 | 84 |
| Example 9 | | | | | | | |
| Comparative | LiNi_{0.5}Co_{0.2}Mn_{0.3}O₂ | Li₄Ti₅O₁₂ | LiFePO₄ | TiO₂(B) | 0.9 | 0.9 | 82 |
| Example 10 | | | | | | | |
| Comparative | LiNi_{0.5}Co_{0.2}Mn_{0.3}O₂ | Li₄Ti₅O₁₂ | LiFePO₄ | Nb₂TiO₇ | 0.9 | 0.9 | 82 |
| Example 11 | | | | | | | |

TABLE 2

| | Discharge capacity retention rate (%) after |
|---|---|
| | 1000 cycles at 45° C. |
| Example 1-1 | 93 |
| Example 2-1 | 96 |
| Example 3-1 | 91 |
| Comparative Example 1-1 | 87 |
| Comparative Example 2-1 | 88 |

While the embodiments of the present invention have been described above, the present invention is not limited thereto, and various modifications can be made within the spirit and scope of the invention described in the appended claims. In addition, in the present invention, implementation steps can be variously modified without departing from the spirit and scope of the invention. Furthermore, various inventions can be made by appropriately combining the plurality of components disclosed in the above embodiment.

What is claimed is:

1. An assembled battery in which
at least one first single cell including a positive electrode containing an active material represented by the general formula LiMO₂ (M includes at least one element selected from the group consisting of Ni, Co, and Mn), and a negative electrode including a titanium-containing oxide, and
at least one second single cell including a positive electrode containing an active material represented by the general formula LiM′PO₄ (M′ includes at least one element selected from the group consisting of Fe, Mn, Co, and Ni) and a negative electrode including a titanium-containing oxide, are connected in series,
wherein the ratio of a charging resistance of the second single cell to a charging resistance of the first single cell is 1 or more and 1.5 or less if an open circuit voltage when the at least one first single cell and the at least one second single cell are connected in series is 4.5 V.

2. The assembled battery according to claim 1,
wherein the ratio of the discharging resistance of the second single cell to the discharging resistance of the first single cell is 1 or more and 1.5 or less if an open circuit voltage when the at least one first single cell and the at least one second single cell are connected in series is 4.0 V.

3. The assembled battery according to claim 1,
wherein the positive electrode containing an active material represented by the general formula LiMO₂ in the first single cell has a layered rock-salt type structure.

4. The assembled battery according to claim 1,
wherein the positive electrode containing an active material represented by the general formula LiM′PO₄ in the second single cell has an olivine type structure.

5. The assembled battery according to claim 1,
wherein the titanium-containing oxide includes at least one of the group consisting of lithium titanate, titanium dioxide, and niobium titanium oxide.

6. A battery pack comprising at least one assembled battery according to claim 1.
